(19) United States
(12) Patent Application Publication
(10) Pub. No.: US 2020/0165483 A1
(43) Pub. Date: May 28, 2020

(54) ONE-COMPONENT COATING COMPOSITION AND SUBSTRATES COATED WITH THE SAME

(71) Applicant: PPG Coatings (Tianjin) Co., Ltd., Tianjin (CN)

(72) Inventors: Wenqing Liu, Tianjin (CN); Juan Wang, Tianjin (CN); Liming Song, Tianjin (CN)

(73) Assignee: PPG Coatings (Tianjin) Co., Ltd., Tianjin (CN)

(21) Appl. No.: 16/622,365

(22) PCT Filed: Jun. 12, 2018
(86) PCT No.: PCT/CN2018/090870

§ 371 Date: Dec. 13, 2019

(30) Foreign Application Priority Data
Jun. 13, 2017 (CN) 201710444473.4

(51) Int. Cl. C09D 167/00

(52) U.S. Cl. CPC C09D 167/00

(57) ABSTRACT

A one-component coating composition comprises a polyester resin, an acrylic resin, and a blocked isocyanate resin, wherein the coat formed from the one-component coating composition has a formaldehyde content of less than 10 ppm. A substrate is coated with the one-component coating composition.

### FIELD OF INVENTION

The present invention relates to a one-component (1K) coating composition substantially free of formaldehyde, and in particular, to a one-component coating composition substantially free of formaldehyde comprising a polyester resin, an acrylic resin, and a blocked isocyanate resin.

### BACKGROUND OF THE INVENTION

A system comprising an acrylic resin, a polyester resin, and a polyurethane resin as main resins plus a cross-linking agent is usually used in the color coat of a water-borne 3C2B (three-coat two-bake) system for an automotive. In such system, a melamine formaldehyde resin containing formaldehyde is uaually used as the cross-linking agent such that the system may be formulated into a 1K (one-component) coating which is convenient in manufacture, storage, and operation with low cost. However, such system also has disadvantages in that formaldehyde could be introduced, and more formaldehyde would be released from the reversible reaction of the water-borne system as the synthetic reaction using the cross-linking agent is reversible. Some system even has a formaldehyde content up to about 1000-2000 ppm. It is well known that formaldehyde can cause heavy harm to the environment and human health. Long-term exposure to low-concentration formaldehyde can cause headache, dizziness, hypodynamia, sensory disability, reduced immunity, and lead to somnolentia, impairment impairment or neurastheria, neurastheria. Chronic toxicity can cause severe harm to the respiratory system. Long-term exposure to formaldehyde can trigger respiratory dysfunction and hepatogenotoxicity lesion, behaved as hepatic cell damage, hepatic radiant energy abnormality. Further, Long-term exposure to formaldehyde increases probability of having unusual cancers like hodgkin lymphoma, multiple myeloma, myelogenous leucocythemia.

Another system usually uses isocyanate as a cross-linking agent, i.e., a 2K (two-component) coating. It has advantages such as excellent appearance property and no formaldehyde introduction, but the 2K coating costs highly in manufacture, storage, and operation.

The present invention is directed to developing a one-component (1K) formaldehyde-free automotive coating composition, which can meet environment requirement on zero formaldehyde and also avoid storage and operation inconvenience caused by the 2K package, and further it can be spray-coated in line with a common water-borne 3C2B system, making it easy to spread and realize.

### SUMMARY OF THE INVENTION

The present invention provides a one-component coating composition comprising a polyester resin, an acrylic resin, and a blocked isocyanate resin, wherein the coat formed from the one-component coating composition has a formaldehyde content of less than 10 ppm.

The present invention also provides a coated substrate, comprising: (1) a substrate, and (2) a one-component coating composition deposited on at least a portion of the substrate, wherein the one-component coating composition comprises a polyester resin, an acrylic resin, and a blocked isocyanate resin, wherein the coat formed from the one-component coating composition has a formaldehyde content of less than 10 ppm.

### DESCRIPTION OF THE INVENTION

Other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, the weight average molecular weight (Mw) of a polymer is determined by a gel permeation chromatography using an appropriate standard such as a polystyrene standard.

As used herein, the term “acid value” (or “neutralization number” or “acid number” or “acidity”) is the mass of potassium hydroxide (KOH) in milligrams that is required to neutralize free acid in one gram of sample, expressed in an unit of mg KOH/g.

As used herein, the term “amine value” is the acid that is required to neutralize one gram of an amine curing agent, expressed in an unit of mg KOH/g.

The one-component coating composition comprises a polyester resin, an acrylic resin and a blocked isocyanate resin.

The polyester resin may comprise the reaction product of a polyacid and a polyol. The polyester resin may be formed from any suitable polyacid and any suitable polyol.

Suitable examples of the polyacid include, but are not limited to one or more of the following: maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylicacid; chlorendic anhydride; 1,3-cyclohexane dicarboxylic acid; 1,4-cyclohexane dicarboxylic acid; tricyclodecanepolycarboxylic acid; endomethylenetetrahydrophthalicacid; endoethylenehexahydrophthalic acid; cyclohexanetetra carboxylic acid; cyclobutanetetracarboxylic; acids and anhydrides of all the aforementioned acids and combinations thereof.

Suitable examples of the polyol include, but are not limited to one or more of the following: alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethylpentanediol and 2-methylpentanediol; cyclohexanedimethanol; hexanediols including 1,6-hexanediol; caprolactonediol (for example, the reaction product of epsilon-capro lactone and ethylene glycol); hydroxyalkylatedbisphenols; polyether glycols, for example, poly(oxytetramethylene) glycol; trimethylol propane; pentaerythritol; di-pentaerythritol; trimethylol ethane; trimethylol butane; dimethylol cyclohexane; glycerol and the like or combinations thereof.

Preferably, the polyester resin useful for the coating composition of the present invention may comprise one polyester resin or a combination of more than one polyester resin. More preferably, the polyester resin useful for the coating composition of the present invention may comprise a high molecular weight polyester resin (a) and a low molecular weight polyester resin (b).

The high molecular weight polyester resin (a) has a weight average molecular weight (Mw) of between about 10,000 and 50,000. Further, the high molecular weight polyester resin has a lower acid value, such as an acid value in the range of from 5 to 20 mgKOH/g. The high molecular weight will contribute to enhancing flexibility and stone-striking resistance of the coat. The acid value will also influence the coat as a whole. A lower acid value may result in lower cross-linking degree and density during the curing, making the resulting coat have high flexibility and good stone-striking resistance. A higher acid value may lead to enhanced cross-linking degree and density during the curing, while the resulting coat will have lower flexibilty but improved adhesion to the substrate. Considering the effects of molecular weight and acid value of the polyester resin on the coat, the coating composition of the present invention employs a combination of a polyester resin having a high Mw and a low acid value range and a polyester resin having a low Mw and a high acid value range. The low Mw polyester resin will be described hereinafter.

The high Mw polyester resin may be present in the coating composition in an amount of 10-25 wt % based on the weight of the coating composition. When the amount of the polyester resin in the coating composition is less than 10 wt %, the resulting coat will exhibit poor stone-striking resistance and flexibility; when the amount of the polyester resin in the coating composition is more than 25 wt %, the resulting coat will show poor humidity or water resistance as the polyester resin is usually poor in humidity or water resistance. Such polyester resin may be commercially available, and examples thereof may include, but are not limited to for example VSM6299W/42WA from allnex, and the like.

The low molecular weight polyester resin (b) has a weight average molecular weight (Mw) of between about 3,000 and 6,000. The introduction of such polyester resin into the coating composition mainly functions to replace the melamine formaldehyde resin for dispersing aluminum paste. The inventors surprisingly find that use of such low Mw polyester resin instead of the melamine formaldehyde resin can achieve better dispersion of aluminum paste. The low Mw polyester resin has a high acid value, such as one in the range of from 30 to 60 mgKOH/g. The high acid value in such range can increase cross-linking degree and density during the curing, such that the resulting coat has low flexibility but improved adhesion to the substrate. Such type of polyester resin can hence impart high cross-linking density to the system and increase the mechanical property thereof.

The low Mw polyester resin may be present in the coating composition in an amount of 0-15 wt % and preferably 1-15 wt % based on the weight of the coating composition. When the amount of the polyester resin in the coating composition is more than 15 wt %, the resulting coat will show reduced stone-striking resistance. Such polyester resin may be commercially available, and examples thereof may include, but are not limited to for example SETAL 6306 SS 60 from Nuplex, and the like.

Suitable acrylic resins may be a homopolymer or a copolymer, which can be polymerized by one or more monomers selected from the group consisting of acrylic acid, methacrylic acid, methyl acrylate, ethyl acrylate, butyl acrylate, iso-butyl acrylate, (3-hydroxy ethyl acrylate, iso-octyl acrylate, isobornyl acrylate, lauryl acrylate, hydroxy butyl acrylate, 2-hydroxypropyl acrylate, octadecyl acrylate, methyl methacrylate, ethyl methacrylate, butyl methacrylate, iso-butyl methacrylate, (3-hydroxy ethyl methacrylate, styrene, iso-octyl methacrylate, isobornyl methacrylate, lauryl methacrylate, 2-hydroxypropyl methacrylate, and octadecyl methacrylate.

Preferably, the acrylic resin useful for the coating composition of the present invention may comprise one acrylic resin or a combination of more than one acrylic resin. More preferably, the acrylic resin useful for the coating composition of the present invention may comprise an acrylic resin (a) and an acrylic resin (b).

The acrylic resin (a) preferably has a pH value of 8 to 9, an acid value of 5.5 to 8.5 mgKOH/g and an amine value of 5.6 to 8.4 mgKOH/g. Such type of acrylic resin can impart excellent mechanical, anti-aging, and anti-chemical properties to the system.

The acrylic resin (a) may be present in the coating composition in an amount of 10-30 wt % based on the weight of the coating composition. When the amount of the acrylic resin in the coating composition is less than 10 wt %, it will adversely affect the mechanical property and anti-aging property of the resulting coat. When the amount of the acrylic resin in the coating composition is more than 30 wt %, it will reduce flexibility of the paint film, making it brittle. Such acrylic resin may be commercially available, and examples thereof may include, but are not limited to for example Setaqua 6802 from Nuplex, and the like.

The acrylic resin (b) preferably has a pH value of 6 to 7, an acid value of 2.5 to 6.0 mgKOH/g and an amine value of 0.6 to 2.8 mgKOH/g. Such type of acrylic resin can provide superior thixotropy and will be advantageous to the production, shipping and storage of the coating.

The acrylic resin (b) may be present in the coating composition in an amount of 10-30 wt % based on the weight of the coating composition. The amount thereof in the formula may be adjusted depending on the requirement of various colors on thixotropy. Lower content will reduce the whole thixotropy of the coat and is disadvantageous to the storage stability; while higher content might produce considerably high thixotropy and the viscosity of the coating will increase quickly as the storage time. In order to reduce the operating viscosity, much water may need to be introduced to decrease the solid content of the system. Such acrylic resin may be commercially available, and examples thereof may include, but are not limited to for example SETAQUA 6803 from Nuplex, and the like.

To substantially eliminate or eliminate production of formaldehyde, the present invention uses a blocked isocyanate as a cross-linking agent to replace the melamine formaldehyde resin containing formaldehyde. Because the blocked isocyanate has been blocked by reacting with a compound having active hydrogen atom(s), the chemical linkage formed inside it is relatively weak and thus cannot crosslink with the multi-hydroxy resin system, allowing it to form a one-component system with the multi-hydroxy resin system without needing to separately store. When the one-component coating composition is subjected to a high temperature baking after being applied, the blocked mono-functionality material and isocyanate linkage breaks, and the blocked isocyanate opens ring and releases considerable —NCO functional groups which crosslinks with the hydroxy group (—OH) of the resin to form a film.

The blocked isocyanate as the cross-linking agent is usually present in the coating composition in an amount of 5-12 wt % based on the weight of the coating composition. Preferably, the blocked isocyanate resin, the polyester resin, and the acrylic resin are in a weight ratio of 15:85-40:60.

The coat formed from the one-component coating composition according to the present invention has a formaldehyde content of less than 10 ppm. Further, the coat formed from the one-component coating composition according to the present invention is substantially free of formaldehyde.

The coating composition according to the present invention further comprises 10-20 wt % of a cosolvent component based on the weight of the coating composition. The cosolvent used comprises those commonly used in the water-borne system, including but not limited to ethylene glycol monobutyl ether, propylene glycol methyl ether, and butanol. Depending on the operation environment of the system, the cosolvent may be properly adjusted to achieve good workability. The cosolvent may be available from BASF, Dow Chemical, and the like.

The coating composition according to the present invention further comprises 5-40 wt % of a pigment paste based on the weight of the coating composition. The content of the pigment paste may be considerably different depending on the type of the coating. For example, a metallic paint may comprise 2-5 wt % of pearl or aluminum paste. Therefore, the pigment paste may be present in a low amount of from 5 to 25 wt %. Some plain paint such as a while paint has a high content of the pigment paste which is usually in the range of 25 to 40 wt %. The pigment paste mainly functions to provide color and masking effects. The pigment paste used in the present coating composition comprises pigments commonly used in the water-borne automotive paint system which can achieve excellent coloring effect after grinding. Pigments in the pigment paste may be commercially available from DuPont, Cabot, and the like.

The coating composition according to the present invention may be applied by an electrostatic spray coating. The electrostatic spray coating is a coating method which uses a high voltage electrostatic field to make negatively charged paint particles orientationally move in a direction contrary to the field and adsorbs the paint particles onto the surface of the workpiece. The electrostatic spray coating comprises a spray gun, a spray cup, and an electrostatic spray coating high voltage power. The film thickness may be controlled by adjusting the spray coating flow, shaping air and movement speed of the atomizer. Electrostatic spray coating devices currently used in the market can be useful for applying the present product, such as atomizers of Ecobell2 from Durr, RB 1000 from ABB.

The present invention also provides a coated substrate, comprising a substrate, and a one-component coating composition deposited on at least a portion of the substrate. The substrate that can be coated with the one-component coating composition of the present invention may be any suitable substrates, including but not limited to metal or plastics. Preferably, the substrate comprises a metallic substrate. In particular, the substrate comprises an automotive body and the like.

### EXAMPLE

The following examples are provided to further illustrate the invention, which should not be considered as limiting the invention to the details as described therein. All parts and percentages in the examples and throughout the description are by weight unless otherwise indicated.

Preparation of Coating Compositions

### Example 1

Each component and its amount for preparing the one-component coating composition of Example 1 is shown in Table 1 below and the coating composition is prepared according to the following procedure:

Aluminum paste is premixed with a solvent and polyester resin², and dispersed for 30 mins for ready-to-use;

Polyester resin¹, two acrylic resins and a cross-linking agent are mixed and adjusted to a pH value above 8.0, to which a substrate wetting agent, a leveling agent, and a defoamer are added with stirring. The mixture is stirred for 30 mins, and a cosolvent is added with stirring and mixed for 1 hr;

The pigment paste is added with stirring and mixed for 30 mins; and

Previously premixed aluminum paste is added and stirred for 30 mins to produce the coating composition of the present Example.

### Comparative Example 1

Each component and its amount for preparing the one-component coating composition of Comparative Example 1 is shown in Table 1 below and the coating composition is prepared according to the following procedure:

Aluminum paste is premixed with a solvent and an amino resin, and dispersed for 30 mins for ready-to-use;

Polyester resin and acrylic resin are mixed and adjusted to a pH value above 8.0, to which a substrate wetting agent, a leveling agent, and a defoamer are added with stirring. The mixture is stirred for 30 mins, and then a cosolvent is added with stirring and mixed for 1 hr;

The pigment paste is added with stirring and mixed for 30 mins; and

Previously premixed aluminum paste is added and stirred for 30 mins to produce the coating composition of the Comparative Example.

TABLE 1
Formulation of Example's and Comparative
Example's coating compositions

| | Example 1 | Comparative |
|---|---|---|
| | (wt %*) | Example 1 (wt %) |
| Polyester Resin ¹ | 15 | 17 |
| Polyester Resin ² | 2 | 0 |
| Acrylic Resin ³ | 15 | 15 |
| Acrylic Resin ⁴ | 15 | 15 |
| Cross-linking agent⁵ | | 7 |
| Cross-linking agent ⁶ | 7 | |
| Pigmented Filler⁷ | 15 | 15 |
| Adjuvant⁸ | 2 | 2 |
| Solvent⁹ | 10 | 10 |
| Water | 19 | 19 |
| Total | 100 | 100 |

*based on the total weight of the coating composition (g):
¹ Polyester Resin VSM6299W/42WA, supplied by allnex,
² Polyester Resin SETAL 6306 SS 60, supplied by Nuplex,
³ Acrylic Resin Setaqua 6802, supplied by Nuplex,
⁴ Acrylic Resin Setaqua 6803, supplied by Nuplex,
⁵Amino Resin RESIMENE 741 (Pentamethoxymethyl melamine formaldehyde resin), supplied by INEOS,
⁶ Blocked Isocyanate BL2794, supplied by Bayer,
⁷Aluminum Paste STAPA IL HYDROLAN VP57510/G, supplied by Eckart; water-borne black paste and water-borne blue paste, supplied by PPG,
⁸Substrate Wetting Agent BYK349, supplied by BYK; Defoamer Surfyl-tg, supplied by Gas Chemical,
⁹Sovlent - ethylene glycol monobutyl ether, propylene glycol methyl ether, and butanol.

Process for Preparation of the Coat:

Firstly, a water-borne basecoat (1225A from PPG a water-borne light grey basecoat) is applied to an electrophoresis plate substrate, which is subjected to flash-drying, dehydration, and baking (150° C., 30 mins) to produce a basecoat plate. Then, the water-borne color paints of Example 1 and Comparative Example 1 are applied to the basecoat plate, flash-dried, dehydrated (80° C., 5 mins), and cooled to room temperature. Finally, a clear coat (CC2000 1K from PPG, solvent-based high-tech finish varnish) is spray-coated, flash-dried, and baked at 140° C. for 30 mins, to produce coated substrates. The coated substrates are tested for the following performance.

Performance Tests

1. Result Comparison of Formaldehyde Content Test for Wet Paints

The formaldehyde content is measured according to GB/T23993-2009 (measurement of formaldehyde content in a water-borne coating) by using an acetylacetone spectrophotometric method. Formaldehyde in the sample is distilled out via a distillation process. Formaldehyde in the fraction will react with acetylacetone with heating in an acetic acid-ammonium acetate buffering solution of pH 6.0 to generate a stable yellow complex. After cooling, absorbance is measured at 412 nm. The formaldehyde content in the sample is calculated based on the standard working curve.

TABLE 2
Formaldehyde Content Comparision between the
Invention Example and Comparative Example

| Sample Plate | Formaldehyde Content |
|---|---|
| Example 1 | 7 ppm |
| Comparative Example 1 | 1200 ppm |

From the result comparison of formaldehyde content test above, it is observed that the coat formed from the one-component coating composition of the Invention Example 1 has a formaldehyde content far less than that of the coat formed from the coating composition of Comparative Example 1 using melamine formaldehyde as the cross-linking agent.

2. Appearance Comparison

For comparing the appearance, a robot spinning cup atomizer is used to stimulate on-site spray coating. The appearance data are obtained by measurements via a BYK wavescan.

TABLE 3
Appearance Data Comparison between Invention
Example and Comparative Example

| | Basecoat Formula | DOI | LW | SW |
|---|---|---|---|---|
| H | Example 1 | 85 | 4 | 18 |
| | Comparative Example 1 | 85 | 4 | 19 |
| V | Example 1 | 84 | 6.6 | 22 |
| | Comparative Example 1 | 84 | 7 | 22 |

Remark:
H: representing horizonal sample plate which maintains horizontal during spray coating and baking; V: representing vertical sample plate which maintains vertical during spray coating and baking; DOI: representing clarity and brightness of images reflected on the surface of the paint film; LW and SW: representing long wave and short wave, respectively, a technical indicator for showing the state of ripple on the paint film surface in an Orange Peel instrument.

It is observed from the appearance data above that the coat formed from the one-component coating composition of the Invention Example 1 has appearance data substantially consistent with those of the coat formed from the coating composition of Comparative Example 1.

3. Other Properties' Comparisons between Invention Example 1 and Comparative Example 1

According to the Table below, the coating compositions of Example 1 and Comparative Example 1 are tested for the following properties and results are shown in Table 4 below.

TABLE 4
Comparisons of Various Properties

| | | | | Comparative |
|---|---|---|---|---|
| Testing Items | Testing Description | Testing Method | Example 1 | Example 1 |
| Hardness | Pencil Hardness ≥ H | GB/T 6739 | H | H |
| Adhesion | Rating 0-1, no considerable | GB/T 9286 | 0 | 0 |
| | difference between wet | | | |
| | grinding zone and | | | |
| | non-grinding zone (cross | | | |
| | hatch) | | | |
| Impact Resistance | ≥20 kg · cm | GB/T1732 | >30 | >30 |
| Cup Drawing | ≥3 mm | GB/T 9753 | 6 | 6 |
| Stone-striking | Superior over 5B | ASTM3170 | 5A | 5A |
| Resistance | | | | |
| Gasoline | Inserting sample into 97# | GB/T1734 | Pass | Pass |
| Resistance | gasoline for 4 hr at room | | | |
| | temperature; no defects | | | |
| | including softening, blistering, | | | |
| | gloss loss, peeling, and | | | |
| | color-changing on the coat | | | |
| | surface at 1 hr after being | | | |
| | taken out | | | |
| Fuel Resistance | Inserting sample into 0# diesel | GB/T 9265 | Pass | Pass |
| | for 4 hr at room temperature; | | | |
| | no defects including softening, | | | |
| | blistering, gloss loss, peeling, | | | |
| | and color-changing on the | | | |
| | coat surface at 1 hr after being | | | |
| | taken out | | | |
| Gasoline-wiping | Same above, no undue | GB/T1734 | Pass | Pass |
| Resistance | blushing in zones wiped by | | | |
| | 97# gasoline | | | |
| Humidity | Exposing sample for 96 hr in a | GB/T 1740 | Pass | Pass |
| Resistance | closed chamber at a | | | |
| | temperature of 47 ± 1° C. and | | | |
| | relative humidity of 96 ± 2%, | | | |
| | no defects including softening, | | | |
| | blushing, blistering, gloss | | | |
| | loss, peeling, and | | | |
| | color-changing on the coat | | | |
| | surface at 1 hr after being | | | |
| | taken out, | | | |
| | Composite Rating: GB 1 adhesion: rating 1 | | | |
| Water Resistance | Dipping sample for 96 h at | GB/T 5209 | Pass | Pass |
| | 40 ± 2° C., appearance showing | | | |
| | no blistering, wrinkling, | | | |
| | adhesion: rating 0-1 | | | |
| Alkaline | Inserting sample into an | GB/T 9265 | Pass | Pass |
| Resistance | alkaline liquor for 4 hr at room | | | |
| (0.1 mol/L | temperature; no defects | | | |
| NaOH) | including softening, blistering, | | | |
| | gloss loss, peeling, and | | | |
| | color-changing on the coat | | | |
| | surface at 1 hr after being taken | | | |
| | out | | | |
| Acid Resistance | Inserting sample into an acid | GB/T 9265 | Pass | Pass |
| (0.05 mol/L | liquor for 4 hr at room | | | |
| H₂SO₄) | temperature; no defects | | | |
| | including no paste, floating, no | | | |
| | speckle, blistering, gloss loss, | | | |
| | on the coat surface at 1 hr after | | | |
| | being taken out | | | |
| Salt-fog | 1000 h | GB/T 1771 | Pass | Pass |
| Resistance | 1. Single-side expanded | | | |
| | corrosion <2 mm, no defects | | | |
| | including rusting, blistering, | | | |
| | cracking, flaking, bronzing in | | | |
| | other zones; adhesion and | | | |
| | hardness remaining no | | | |
| | reduction in 1 hr of the | | | |
| | salt-fog test; | | | |
| | 2. Pitting corrosion or | | | |
| | structural damage caused by | | | |
| | rusting should not occur in | | | |
| | five years (200,000 Km) for | | | |
| | use in the South area of the | | | |
| | Yangtze River | | | |
| Resistance to | Exposure time 1500 h; | GB/T 1865 | Pass | Pass |
| Accelerated | Composite rating including | | | |
| Ageing | cracking, blistering, wrinkling, | | | |
| | bronzing: GB 1; | | | |
| | Adhesion, rating 1gloss loss ≤20%; | | | |
| | Hardness ≥ HB; | | | |
| | Impact Resistance ≥20 kg · cm | | | |

It is observed from the Table above that the one-component coating composition of the present invention is comparable to the coating composition of the Comparative Example in various properties, but the formaldehyde content thereof is far below that of the Comparative Example.

Although particular aspects of this invention have been explained and described above, it will be evident to those skilled in the art that numerous variations and modifications to the present invention may be made without departing from the scope and spirit of the present invention. Therefore, the appended claims are intended to encompass these variations and modifications falling within the present invention.

1. A one-component coating composition comprising a polyester resin, an acrylic resin, and a blocked isocyanate resin, wherein the coat formed from the one-component coating composition has a formaldehyde content of less than 10 ppm.

2. The one-component coating composition of claim 1, wherein the blocked isocyanate resin, the polyester resin, and the acrylic resin are in a weight ratio of 15:85-40:60.

3. The one-component coating composition of claim 1, wherein the polyester resin comprises a mixture of a polyester resin (a) and a polyester resin (b).

4. The one-component coating composition of claim 3, wherein the polyester resin (a) has an acid value of 5 to 20 mgKOH/g and a weight average molecular weight of 10,000 to 50,000.

5. The one-component coating composition of claim 3, wherein the polyester resin (b) has an acid value of 30 to 60 mgKOH/g and a weight average molecular weight of 3,000 to 6,000.

6. The one-component coating composition of claim 1, wherein the acrylic resin comprises a mixture of an acrylic resin (a) and an acrylic resin (b).

7. The one-component coating composition of claim 6, wherein the acrylic resin (a) has a pH value of 8 to 9, and an acid value of 5.5 to 8.5 mgKOH/g and an amine value of 5.6 to 8.4 mgKOH/g.

8. The one-component coating composition of claim 6, wherein the acrylic resin (b) has a pH value of 6 to 7, and an acid value of 2.5 to 6.0 mgKOH/g and an amine value of 0.6 to 2.8 mgKOH/g.

9. The one-component coating composition of any of the preceding claims, wherein the coat formed from the one-component coating composition is substantially free of formaldehyde.

10. A coated substrate, comprising:
(i) a substrate, and
(ii) a one-component coating composition deposited on at least a portion of the substrate, the one-component coating composition comprising a polyester resin, an acrylic resin, and a blocked isocyanate resin, wherein the coat formed from the one-component coating composition has a formaldehyde content of less than 10 ppm.

11. The coated substrate of claim 10, wherein the substrate comprises an automotive body.
